(19) United States
(12) Patent Application Publication
(10) Pub. No.: US 2026/0052006 A1
(43) Pub. Date: Feb. 19, 2026

(54) METHOD FOR COMMAND COMMUNICATION, DEVICE FOR COMMAND COMMUNICATION AND STORAGE MEDIUM

(71) Applicant: Tymphany HK Limited, Hong Kong (HK)

(72) Inventor: Sheng-Pin WANG, Taipei City (TW)

(21) Appl. No.: 18/804,847

(22) Filed: Aug. 14, 2024

(51) Int. Cl. H04L 9/06; H04L 69/22

(52) U.S. Cl. CPC H04L 9/0643; H04L 9/065; H04L 69/22; H04L 9/0668

(57) ABSTRACT

A method for command communication includes: determining whether a command to parse conforms to a preset rule, wherein the preset rule includes: the command starts by a preset starting byte and terminates by a preset terminating byte, and each of the other bytes in the command except the preset starting byte and the preset terminating byte is a valid byte with a correct position; if determining that the command conforms to the preset rule, performing calculation on the index of each byte in the command by a preset calculation method to generate corresponding data; when determining that the command exists in a command set, parsing the command by translating the data.

### TECHNICAL FIELD OF THE INVENTION

The present disclosure is related to a method for command communication, a device for command communication and a storage medium.

### DESCRIPTION OF THE PRIOR ART

In the communication between two assemblies, some commands are usually used to perform handshaking or transfer information with each other. Performing command parsing is time-consuming and is limited by the computing ability of a processor.

In order to reduce computing time or the processes in codes, if command sets are designed to be simple, command words/strings are usually long (represented in hexadecimal numbers or decimal numbers). Thus, although the command sets are designed to be simple to be easily implemented or run, the command sets are hard to read and maintain so that programmers have difficulty in reading and maintaining the commands. If the commands are designed to be easily read, parsing and translating would become time-consuming.

### SUMMARY

In light of the aforementioned problems in the prior art, the present disclosure provides a method for command communication, a device for command communication and a storage medium to be able to handle and parse the command efficiently.

The technical solutions of the present disclosure are implemented as follows:

According to one aspect of the present disclosure, the method for command communication is provided and includes: determining whether a command to parse conforms to a preset rule to generate a determination result, wherein the preset rule comprises: the command starts by a preset starting byte and terminates by a preset terminating byte, and each of the other bytes in the command except the preset starting byte and the preset terminating byte is a valid byte with a correct position; if the determination result is that the command conforms to the preset rule, performing calculation on the index of each byte in the command by a preset calculation method to generate corresponding data; when determining that the command exists in a command set, parsing the command by translating the data

According to the embodiments of the present disclosure, the method for command communication further includes: if the determination result is that the command does not conform to the preset rule, deleting the command which is not determined to conform to the preset rule.

According to the embodiments of the present disclosure, the calculation is hash calculation.

According to the embodiments of the present disclosure, determining whether the command in command sets conforms to the preset rule includes: determining whether the starting byte of the command in the command set is the preset starting byte; if determining that the starting byte of the command in the command set is the preset starting byte, sequentially determining whether each of bytes of the command in the command set after the starting byte is valid and is located on the correct position.

According to another aspect of the present disclosure, the device for command communication is provided and includes a determination module, a calculation module, and a translation module. The determination module is configured to determine whether a command to parse conforms to a preset rule to generate a determination result, wherein the preset rule include: the command starts by a preset starting byte and terminates by a preset terminating byte, and each of the other bytes in the command except the preset starting byte and the preset terminating byte is a valid byte with a correct position. The calculation module is configured to perform calculation on the index of each byte in the command by a preset calculation method to generate corresponding data if the determination result of the determination module is that the command conforms to the preset rule. The translation module is configured to parse the command by translating the data when determining that the command exists in a command set.

According to the embodiments of the present disclosure, the device for command communication further includes a deletion module. The deletion module is configured to delete the command which is not determined to conform to the preset rule if the determination result of the determination module is that the command does not conform to the preset rule.

According to the embodiments of the present disclosure, the calculation is hash calculation.

According to the embodiments of the present disclosure, the determination module is configured to determine whether the starting byte of the command in the command set is the preset starting byte, and if determining that the starting byte of the command in the command set is the preset starting byte, the determination module is configured to sequentially determine whether each of bytes of the command in the command set after the starting byte is valid and is located on the correct position.

According to yet another aspect of the present disclosure, the storage medium is provided and stores a program, and the program is performed to implement the aforementioned method for the command communication. then performs the command parsing on

The present disclosure performs selection on the command by the preset rule before parsing the command and then utilizes the data generated by the index to perform the command parsing in order to substitute the method of the current command parsing by comparing the strings. In comparison with the method of the current command parsing by comparing the strings, the method provided by the present disclosure does not require any comparison mechanism and only takes the time of determining the validity of the bytes and performing the calculation and may therefore avoid the time of comparing the strings and extremely decrease the size of a buffer area to handle and parse the command efficiently.

### BRIEF DESCRIPTION OF DRAWINGS

In order to clearly explain the embodiments of the present disclosure or the technical solution in the prior art, the accompanying drawings which the embodiments of the present disclosure need to use are simply introduced. Obviously, the described accompanying drawings as follows are merely some embodiments of the present disclosure. Based on the following accompanying drawings, the other accompanying drawings would be obtained by the person in the art without inventive steps.

FIG. 1 depicts a flowchart of a method for command communication according to one embodiment of the present disclosure.

FIG. 2 depicts a flowchart of a method for command communication according to another embodiment of the present disclosure.

FIG. 3 depicts a schematic diagram of a command set according to one embodiment of the present disclosure.

FIG. 4 depicts a block diagram of a device for command communication according to one embodiment of the present disclosure.

### DETAILED DESCRIPTION

The specific embodiments of the present disclosure given herein below is used to clearly and completely explain the technical solution of the present disclosure. Apparently, the described embodiments are merely one part of the embodiments of the present disclosure and not all embodiments of the present disclosure. Based on the embodiments of the present disclosure, all of the other embodiments obtained by the person skilled in the art shall fall within the scope of protection of the present disclosure.

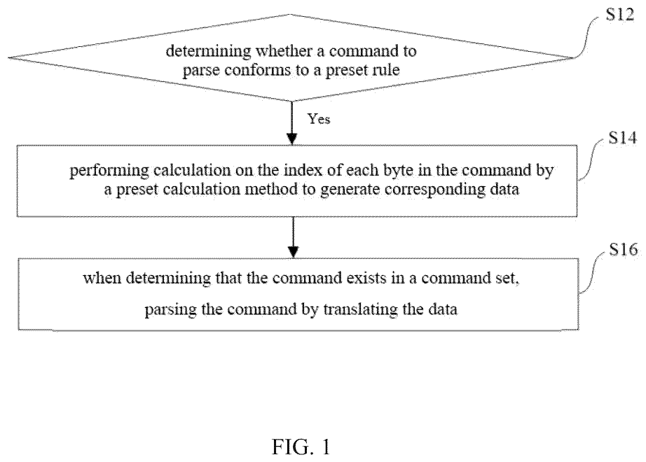

As shown in FIG. 1, a method for command communication according to the embodiments of the present disclosure includes:
Step S12: before parsing a command, determining whether the command to parse conforms to a preset rule. The preset rule is set as follows: the command starts by a preset starting byte and terminates by a preset terminating byte, and each of the other bytes in the command except the preset starting byte and the preset terminating byte is a valid byte with a correct position.

If the determination result at step S12 is that the command conforms to the preset rule, step S14 is performed. Because each word/byte has a corresponding index disposed on the position thereof, the index of each byte in the command may be calculated by a preset calculation method to generate corresponding data. In one embodiment, hash calculation may be performed on the indexes of bytes to generate hash data. In the other embodiments, the other proper calculation methods may be adopted to encrypt the index of each byte to generate the corresponding data.

Step S16: when determining that the command exists in a command set, parsing the command by translating the data generated by the aforementioned calculation. In the embodiment of adopting the hash calculation to generate the hash data, the corresponding hash data are translated to parse the command in this step.

In the aforementioned technical solution of the present disclosure, the selection is performed on the command by the preset rule before the command is parsed, and then the data generated by the index is utilized to perform the command parsing in order to substitute the method of the current command parsing by comparing the strings. In comparison with the method of the current command parsing by comparing the strings, the method provided by the present disclosure does not require any comparison mechanism and only takes the time of determining the validity of the bytes and performing the calculation and may therefore avoid the time of comparing the strings and extremely decrease the size of a buffer area to handle and parse the command efficiently.

In addition, in step S12, if the determination result is that the command does not conform to the preset rule, the command which is not determined to conform to the preset rule is deleted, and the step S12 is restarted over.

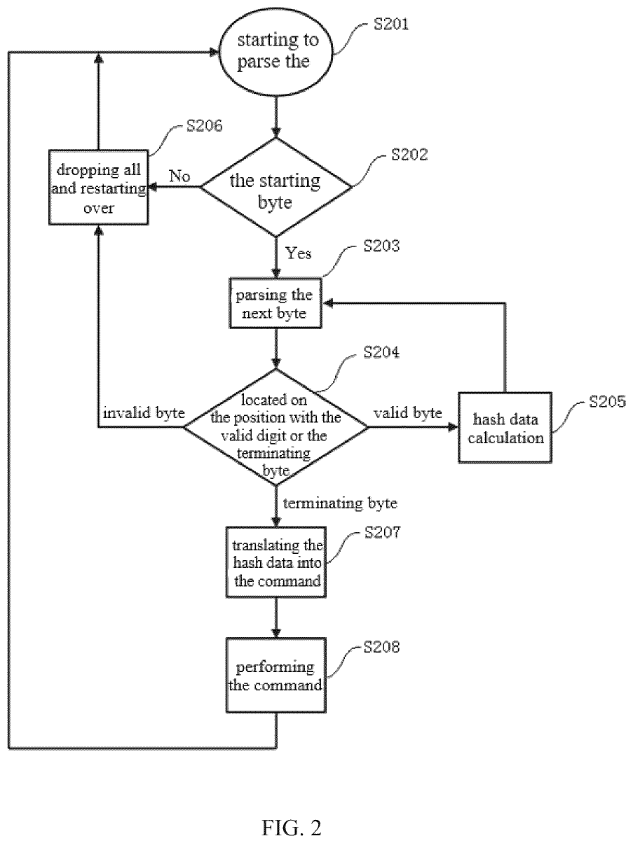

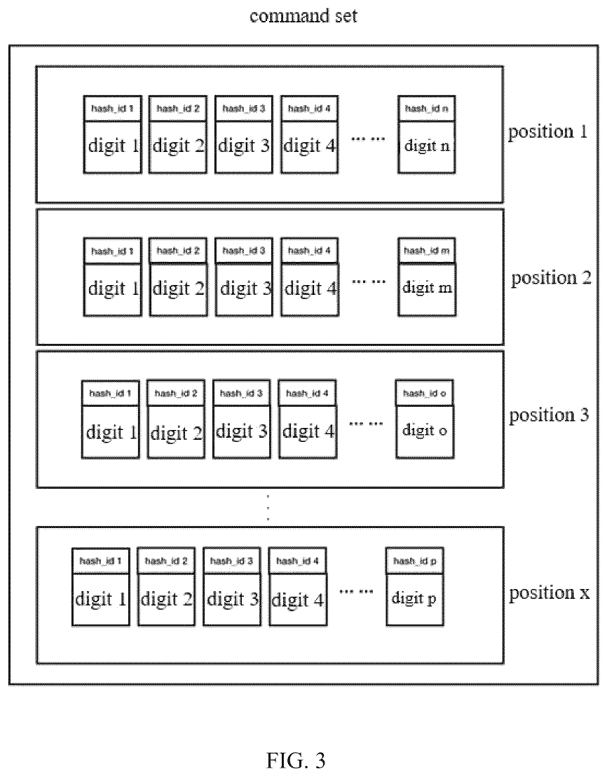

FIG. 2 depicts a flowchart of a method for command communication according to another embodiment of the present disclosure. FIG. 3 depicts a schematic diagram of a command set according to one embodiment of the present disclosure. Combining FIG. 2 with FIG. 3, the method for command communication starts from step S201, and afterwards the determination is performed on the starting byte at step S202. If the starting byte is determined as the predefined starting byte, step S203 is performed. At the step S203, the parsing of the next byte is performed. Thereafter, at step S204, the validity and the position of the byte are determined. Specifically, as shown in FIG. 3, the command set (known as a command digit set) includes a plurality of commands respectively located on a plurality of positions (position1, . . . , position x), and each of the plurality of commands includes a plurality of bytes (digit 1, . . . , digit n, . . . , digit 1, . . . , digit p). At the step S204, the byte is determined whether to be located on the valid digit of the correct position or is determined whether to be located on the predefined terminating byte of the correct position. For example, the correct position is the position of the command in the command set corresponding to the byte and /or the position of the byte in the corresponding command.

If the determination result at step S204 is that the byte is the valid byte, step S205 is performed. At the step S205, the hash data calculation is performed on the index (e.g., ID) of the byte and the corresponding data (e.g., hash_id in FIG. 3) are generated accordingly, and then, the step S203 is returned to perform the parsing of the next byte.

If the determination result at step S204 is that the byte is the invalid byte, step S206 is performed. At the step S206, the entire bytes of the command are dropped, and the step S201 is returned to restart over the process of parsing the command. In addition, if the starting byte is not determined as the predefined starting byte at step S202, and the step S206 is performed in the same way, and the entire bytes of the command are dropped, and the step S201 is returned to restart over the process of parsing the command.

In the loop of the step S204, with reference to FIG. 2, the step S205 and the step S203, when the bytes between the starting byte and the terminating byte are all the valid bytes and are located on the correct positions, the determination is performed on the terminating byte at the step S204 to determine whether the terminating byte is located on the predefined terminating byte of the correct position. If the terminating byte is determined to be located on the predefined terminating byte of the correct position, step S207 is performed. At the step S207, the hash data generated by the hash calculation are translated into the command. Afterwards, the command is performed at step S208.

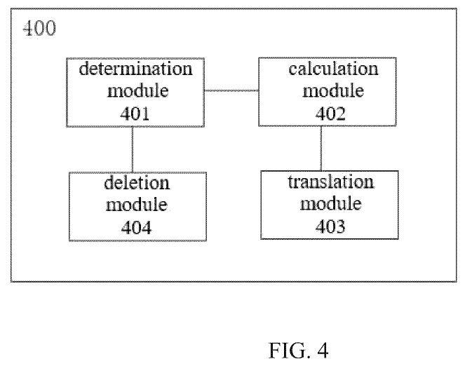

As shown in FIG. 4, a device 400 for command communication according to the embodiments of the present disclosure is provided and includes a determination module 401, a calculation module 402, and a translation module 403.

The determination module 401 is configured to determine whether the command to parse conforms to the preset rule to generate the determination result, wherein the preset rule include: the command starts by the preset starting byte and terminates by the preset terminating byte, and each of the other bytes in the command except the preset starting byte and the preset terminating byte is the valid byte with the correct position.

The calculation module 402 is configured to perform calculation on the index of each byte in the command by the preset calculation method to generate corresponding data if the determination result of the determination module 401 is that the command conforms to the preset rule. In one embodiment, the calculation is the hash calculation.

The translation module 403 is configured to parse the command by translating the data when determining that the command exists in a command set.

In one embodiment, the device 400 for command communication further includes a deletion module 404. The deletion module 404 is configured to delete the command which is not determined to conform to the preset rule if the determination result of the determination module 401 is that the command does not conform to the preset rule.

In one embodiment, the determination module 401 is configured to determine whether the starting byte of the command in the command set is the preset starting byte, and if determining that the starting byte of the command in the command set is the preset starting byte, the determination module 401 is configured to sequentially determine whether each of bytes of the command in the command set after the starting byte is valid and is located on the correct position.

According to the embodiments of the present disclosure, a storage medium is further provided and stores a program, and the program may be performed to implement the aforementioned method for the command communication.

The aforementioned description are the preferred embodiments of the present disclosure and is not used to limit the present disclosure. The variation, equivalent modification, improvement and so on according to the idea and the spirit of the present disclosure should be included within the scope of the protection of the present disclosure.

1. A method for command communication comprising:
determining whether a command to parse conforms to a preset rule to generate a determination result, wherein the preset rule comprises: starting the command by a preset starting byte and terminating the command by a preset terminating byte, and each of the other bytes in the command except the preset starting byte and the preset terminating byte is a valid byte with a correct position;
if the determination result is that the command conforms to the preset rule, performing calculation on an index of each byte in the command by a preset calculation method to generate corresponding data; and
when determining that the command exists in a command set, parsing the command by translating the data.

2. The method for command communication according to claim 1, further comprising, if the determination result is that the command does not conform to the preset rule, deleting the command which is not determined to conform to the preset rule.

3. The method for the command communication according to claim 1, wherein the calculation is a hash calculation.

4. The method for command communication according to claim 1, wherein said determining whether the command in the command set conforms to the preset rule comprises:
determining whether a starting byte of the command in the command set is the preset starting byte; and
if determining that the starting byte of the command in the command set is the preset starting byte, sequentially determining whether each of bytes of the command in the command set after the starting byte is valid and is located on the correct position.

5. A device for command communication comprising:
a determination module configured to determine whether a command to parse conforms to a preset rule to generate a determination result, wherein the preset rule comprises: starting the command by a preset starting byte and terminating the command by a preset terminating byte, and each of other bytes in the command except the preset starting byte and the preset terminating byte is a valid byte with a correct position;
a calculation module configured to perform calculation on an index of each byte in the command by a preset calculation method to generate corresponding data if the determination result of the determination module is that the command conforms to the preset rule; and
a translation module configured to parse the command by translating the data when determining that the command exists in a command set.

6. The device for command communication according to claim 5, further comprising a deletion module configured to delete the command which is not determined to conform to the preset rule if the determination result of the determination module is that the command does not conform to the preset rule.

7. The device for command communication according to claim 5, wherein the calculation is a hash calculation.

8. The device for command communication according to claim 5, wherein the determination module is configured to determine whether a starting byte of the command in the command set is the preset starting byte, and if determining that the starting byte of the command in the command set is the preset starting byte, the determination module is configured to sequentially determine whether each of bytes of the command in the command set after the starting byte is valid and is located on the correct position.

9. A non-transitory, computer-readable storage medium storing a program, wherein the program is performed to implement the method for the command communication according to claim 1.
